(19) United States
(12) Patent Application Publication
(10) Pub. No.: US 2008/0036166 A1
(43) Pub. Date: Feb. 14, 2008

(54) Self-locking sleeve for stabilizer bar

(75) Inventors: Jonathan Russell, Rochester Hills, MI (US); Brian Allen Irwin, Chatham (CA)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Suystems Company, US

(21) Appl. No.: 11/503,833

(22) Filed: Aug. 14, 2006

(51) Int. Cl. B60G 21/055; B60G 21/04

(52) U.S. Cl. 280/124.107; 267/189; 267/276

(57) ABSTRACT

A stabilizer bar includes a sleeve and bushing that are used to mount the stabilizer bar to a vehicle structure. The sleeve is comprised of a plastic material and includes a locking mechanism for locking the sleeve to the stabilizer bar. The bushing is comprised of a resilient material and is mounted to an external surface of the sleeve. Once the sleeve is locked onto the stabilizer bar, lateral movement between the bushing and the stabilizer bar is prohibited. Further, frictional reaction of the bushing occurs between plastic and rubber materials, which results in reduced noise during suspension loading.

### TECHNICAL FIELD

This invention generally relates to a vehicle stabilizer bar assembly with reduced noise bushings.

### BACKGROUND OF THE INVENTION

Stabilizer bars are a well known component of vehicle suspension systems. Conventional arrangements include a metal bar having a laterally extending center portion. Leg portions extend transversely from the center portion, and are coupled to suspension components, such as control arms for example. Rubber bushings and brackets are used to secure the center portion of the stabilizer bar to an appropriate vehicle component.

During normal operation, this conventional arrangement tends to generate objectionable noise, which results from rubbing action between the rubber bushings and an outer surface of the metal bar. Various attempts have been made to eliminate this objectionable noise. One solution has been to fix the rubber bushings to the stabilizer bar under compression or bonding so that the bushing works in torsion with the stabilizer bar. However, this requires additional assembly and/or processing steps, which increases cost.

Another problem with conventional stabilizer bars is that relative movement between the rubber bushings and the stabilizer bar occurs under suspension cycling. Once the stabilizer bar is fixed to the vehicle component with the rubber bushings, the stabilizer bar can be subjected to lateral movement relative to the bushings during suspension load cycling. This type of lateral movement is often referred to as “walking” and stabilizer bars often include some type of “anti-walk” feature to prevent this movement.

One anti-walk feature comprises a ring that is welded or crimped to the stabilizer bar adjacent the rubber bushing. Another type of anti-walk feature comprises a deformation portion formed in the stabilizer bar itself during a heat treatment process. These solutions require additional processing steps and are not always effective.

Thus, there is a need for an improved stabilizer bar arrangement that reduces noise, and which provides an anti-walk features, as well as overcoming the other above-mentioned deficiencies in the prior art.

### SUMMARY OF THE INVENTION

A stabilizer bar includes a sleeve and a bushing that cooperate to provide an anti-walk feature and to reduce noise during cycling. The bushing is mounted to an external surface of the sleeve. The sleeve includes a locking mechanism that is actuated to lock the sleeve to the stabilizer bar to prevent lateral movement between the stabilizer bar and the bushing.

In one example, the sleeve is made from a plastic material and the bushing is made from a resilient material, such as rubber. Noise is reduced because a frictional interface for the bushing is formed between a plastic sleeve and a rubber bushing instead of between a metal stabilizer bar and a rubber bushing.

In one example, the locking mechanism is integrally formed with the sleeve as a single piece component. The sleeve comprises a cylinder that extends along an axis between first and second ends. In one example configuration, the locking mechanism includes a slot portion having a first plurality of teeth and an extension portion including a second plurality of teeth. At least one of the slot portion and extension portion is moved in a direction transverse to the axis such that the first and second pluralities of teeth engage each other to lock the sleeve to the stabilizer bar. Once the sleeve is locked, lateral movement between the bushing and the stabilizer bar is effectively prohibited.

These and other features of the present invention can be best understood from the following specification and drawings, the following of which is a brief description.

### BRIEF DESCRIPTION OF THE DRAWINGS

FIG. 1 comprises a stabilizer bar assembly incorporating an example of the subject invention.

FIG. 2 is magnified portion of FIG. 1 as seen from an opposite view from that of FIG. 1.

FIG. 3 is perspective view of an example of a sleeve and bushing assembly of the subject invention mounted to a stabilizer bar.

FIG. 4 is a perspective view of the sleeve alone.

FIG. 5 is a cross-sectional view of the sleeve and bushing mounted to the stabilizer bar.

### DETAILED DESCRIPTION OF THE PREFERRED EMBODIMENT

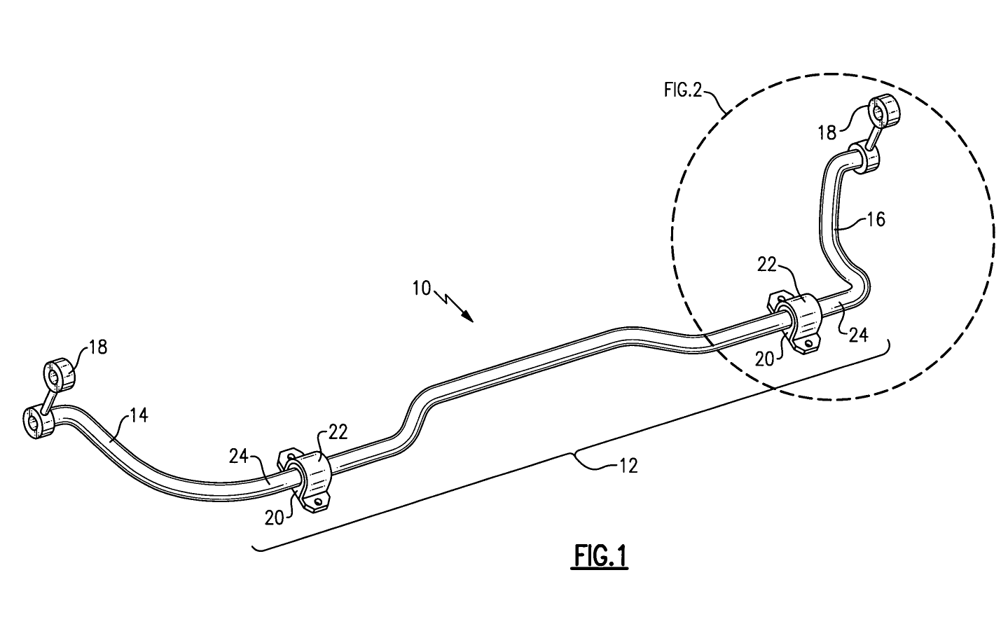

As shown in FIG. 1, a stabilizer bar 10 includes a central portion 12 that extends generally in a lateral direction between laterally spaced wheels (not shown). The stabilizer bar 10 includes a first leg 14 extending in a longitudinal direction from one end of the central portion 12 and a second leg 16 extending in a longitudinal direction from an opposite end of the central portion 12. The first 14 and second 16 legs each include a link member 18 that is used to couple the first 14 and second 16 legs to corresponding suspension components (not shown), such as control arms for example.

The stabilizer bar 10 includes at least one bushing assembly 20 that is used mount the stabilizer bar 10 to a vehicle structure (not shown), such as a frame or rail member for example. Two bushing assemblies 20 are shown in the example of FIG. 1. Each bushing assembly 20 is mounted to the vehicle structure with a clamp 22.

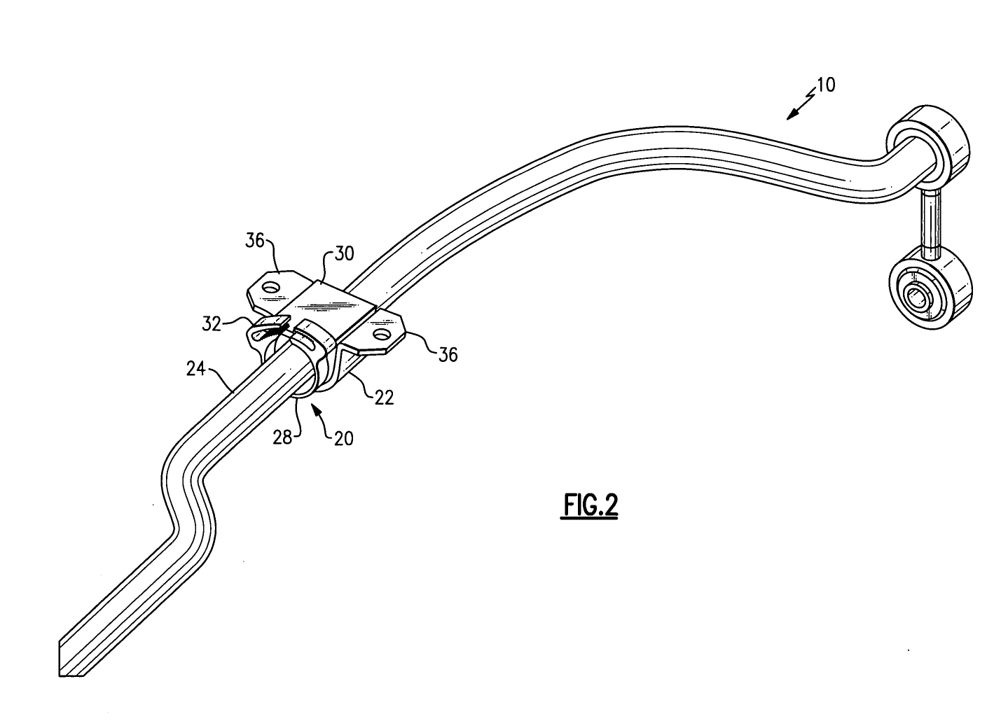

The bushing assembly 20 is shown in greater detail in FIG. 2. The central portion 12 of the stabilizer bar 10 can be straight or can include bends as shown in FIG. 1, however a substantial portion of the central portion 12 extends in a lateral direction between laterally spaced vehicle wheels.

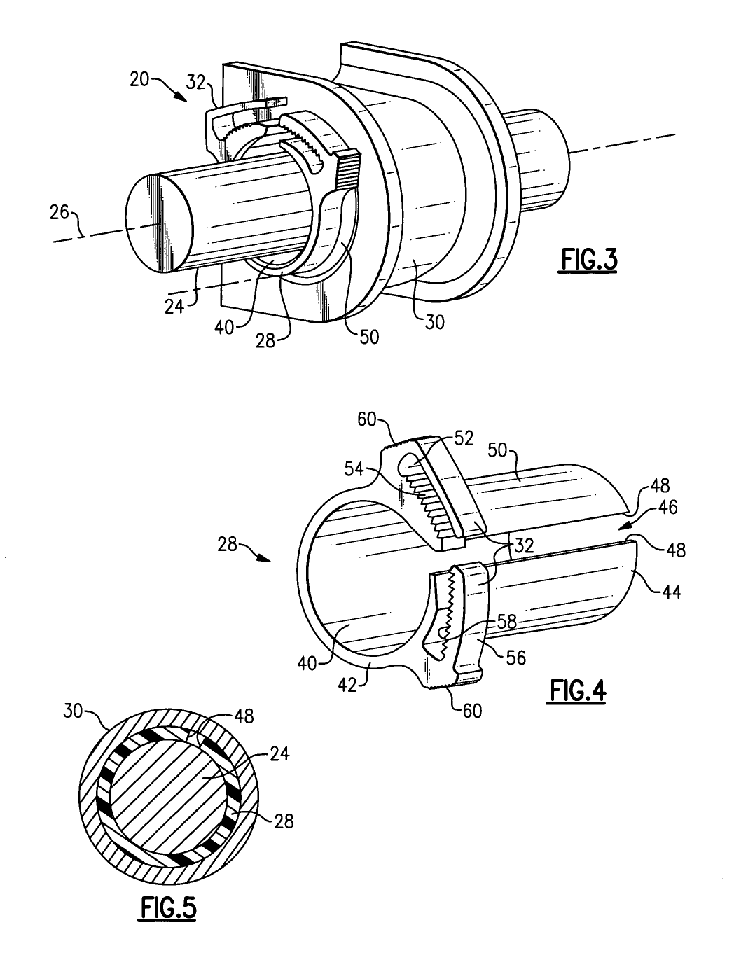

As shown in FIG. 2, the bushing assembly 20 is mounted to a portion 24 of the stabilizer bar 10 that defines an axis 26 (see FIG. 3). The bushing assembly 20 includes a sleeve 28 and a bushing 30 mounted to an external surface of the sleeve 28. The sleeve 28 includes a locking mechanism 32 that is used to lock the sleeve 28, and associated bushing 30, to the stabilizer bar 10. The clamp 22 at least partially surrounds an external surface of the bushing 30 and includes mounting flanges 36 for attachment to the vehicle structure.

The sleeve 28 and bushing 30 are shown in greater detail in FIGS. 3 and 4. The sleeve 28 comprises a cylindrical component with an internal bore 40 that extends between first 42 and second 44 ends of the sleeve 28. The stabilizer bar 10 is received within the internal bore 40. A slit 46 extends from the first end 42 to the second end 44 to define spaced apart edges 48 (see FIG. 5) when the locking mechanism 32 is in an unlocked position. Thus, the internal bore 40 does not comprise a surface that extends 360 degrees about the axis 26, at least when the locking mechanism 32 is unlocked. The slit 46 allows the size of the internal bore 40 to be reduced as the locking mechanism 32 is moved from an unlocked position to a locked position. This will be discussed in greater detail below.

The sleeve 28 defines an outer surface 50. The bushing 30 is directly mounted to this outer surface 50. The bushing 30 can be a separate piece or can be molded or bonded to the sleeve 28 to form a single piece component. The bushing 30 may or may not include a slit comparable to slit 46 of sleeve 28 depending on a desired attachment configuration between bushing 30 and sleeve 28.

In one example, the sleeve 28 is formed from a plastic material and the bushing 30 is formed from a resilient material, such as rubber for example. By using a plastic sleeve to mount the rubber bushing, beneficial noise reduction is provided because a frictional interface for the bushing is formed between a plastic material and a rubber material instead of between a metal material and a rubber material as in prior art configurations.

The locking mechanism 32 is integrally formed as part of the sleeve 28, such that the locking mechanism 32 and sleeve 28 form a single piece component. In the example shown, the locking mechanism 32 is molded as one piece at the first end 42 of the sleeve 28.

The locking mechanism 32 comprises a slot portion 52 that includes a first plurality of teeth 54, and an extension portion 56 that includes a second plurality of teeth 58. At least one of the slot portion 52 and the extension portion 56 is moved in a direction transverse to the axis 26 such that the extension portion 56 is inserted into the slot portion 52. In the example shown, the slot 52 and extension 56 portions each include a grip surface 60 that is engageable by a user to move at least one of the slot portion 52 and extension portion 56. The grip surface 60 preferably includes a textured surface with ridges to prevent slippage during locking.

During insertion, the first 54 and second 58 pluralities of teeth engage each other in ratcheting manner to lock the sleeve 28 and bushing 30 to the stabilizer bar 10. Further, during locking, the edges 48 move toward each other, reducing the size of the internal bore 40, to securely squeeze and clamp the sleeve 28 around the stabilizer bar 10. This secure attachment provides an anti-walk feature that prohibits relative lateral movement between the bushing 30 and the stabilizer bar 10 along the axis 26.

The unique locking sleeve provides a simple and effective method and apparatus for securing a bushing to a stabilizer bar in a manner that prevents unwanted relative movement between the bushing and stabilizer bar during suspension loading. The locking sleeve also provides an additional benefit of noise reduction by providing a mounting interface for the bushing such that the bushing is not mounted directly to the stabilizer bar. The noise reduction is accomplished without having to subject to the bushing to any type of additional processing to fix the bushing under compression to the stabilizer bar.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A stabilizer bar assembly comprising:
a stabilizer bar having a body portion extending along an axis;
a sleeve defining an internal bore that receives said body portion, said sleeve including a locking mechanism; and
a bushing supported on said sleeve wherein said locking mechanism is engaged to fix said sleeve relative to said stabilizer bar such that lateral movement between said bushing and said stabilizer along said axis is prevented.

2. The stabilizer bar assembly according to claim 1 wherein said sleeve includes a cylindrical extension that surrounds at least a portion of said body portion, said bushing being mounted directly to an external surface of said cylindrical extension.

3. The stabilizer bar assembly according to claim 1 wherein said sleeve is comprised of a plastic material and said bushing is comprised of a resilient material.

4. The stabilizer bar assembly according to claim 3 wherein said stabilizer bar is comprised of a metal material.

5. The stabilizer bar assembly according to claim 1 wherein said locking mechanism comprises a slot portion including a first plurality of teeth and an extension portion including a second plurality of teeth with said extension portion being inserted into said slot portion such that said first and second pluralities of teeth engage each other to lock said sleeve to said stabilizer bar.

6. The stabilizer bar assembly according to claim 5 wherein at least one of said slot portion and said extension portion is movable in a direction transverse to said axis.

7. The stabilizer bar assembly according to claim 1 wherein said locking mechanism is actuated by movement in a direction transverse to said axis.

8. The stabilizer bar assembly according to claim 1 wherein said axis extends generally in a lateral direction and wherein said stabilizer bar includes a first leg portion extending from one end of said body portion generally along a first longitudinal axis and a second leg portion extending from an opposite end of said body portion generally along a second longitudinal axis, said first and second leg portions adapted for mounting to a suspension component.

9. The stabilizer bar assembly according to claim 1 wherein said stabilizer bar is adapted to extend between laterally spaced vehicle wheels.

10. The stabilizer bar assembly according to claim 1 wherein said sleeve comprises a cylinder having a first end and a second end with a slit extending from said first end to said second end such that a size of said internal bore is reduced as said locking mechanism is moved from an unlocked position to a locked position.

11. The stabilizer bar assembly according to claim 10 wherein said locking mechanism is integrally formed with said first end of said sleeve, and wherein said bushing is mounted directly to an external surface of said sleeve at said second end.

12. A vehicle suspension comprising:
a suspension component having a body portion extending along an axis;
a sleeve defining an internal bore that receives said body portion, said sleeve including a locking mechanism integrally formed with said sleeve as a single piece; and
a bushing mounted to an external surface of said sleeve wherein said locking mechanism is moved from an unlocked position to a locked position to fix said sleeve relative to said suspension component such that lateral movement between said bushing and said suspension component along said axis is prevented.

13. The vehicle suspension according to claim 12 including a clamp mounted to an external surface of said bushing, said clamp being mountable to a vehicle structure.

14. The vehicle suspension according to claim 12 wherein said sleeve comprises a cylinder having a first end and a second end with a slit extending from said first end to said second end such that a size of said internal bore is reduced as said locking mechanism is moved from said unlocked position to said locked position.

15. The vehicle suspension according to claim 14 wherein said locking mechanism comprises a slot portion including a first plurality of teeth and an extension portion including a second plurality of teeth with said extension portion being inserted into said slot portion such that said first and second pluralities of teeth engage each other to lock said sleeve to said stabilizer bar and wherein at least one of said slot portion and said extension portion is movable in a direction transverse to said axis.

16. The vehicle suspension according to claim 15 wherein said suspension component comprises a stabilizer bar with a central portion extending in a lateral direction and first and second leg portions extending in a longitudinal direction, said first and second leg portions being adapted for attachment to corresponding control arms, and wherein said central portion of said stabilizer bar comprises said body portion of said suspension component.

17. A method of assembling a stabilizer bar assembly comprising the steps of:
(a) providing a plastic sleeve with a rubber bushing supported on an external surface of the plastic sleeve;
(b) at least partially surrounding a portion of a stabilizer bar with the plastic sleeve;
(c) actuating a locking mechanism formed on the plastic sleeve to lock the plastic sleeve to the stabilizer bar; and
(d) securing a clamp to the rubber bushing.

18. The method according to claim 17 wherein the plastic sleeve comprises a cylinder extending along an axis and wherein step (c) includes inserting a first member into a second member in a direction transverse to the axis to lock the plastic sleeve to the stabilizer bar.
